(19) United States
(12) Patent Application Publication
(10) Pub. No.: US 2020/0193723 A1
(43) Pub. Date: Jun. 18, 2020

(54) PARKING METER FREE NFC PARK AND PAY

(71) Applicant: Galatea Technology LLC, San Dimas, CA (US)

(72) Inventor: Chi Huynh, San Dimas, CA (US)

(21) Appl. No.: 16/219,283

(22) Filed: Dec. 13, 2018

(51) Int. Cl. G07B 15/06; G06Q 20/32

(52) U.S. Cl. CPC G07B 15/063; G06Q 2240/00; G06Q 20/3278

(57) ABSTRACT

A Near Field Communication (NFC) system is provided for managing a parking area having multiple parking spots. The system includes a set of NFC tags. Each of the NFC tags is assigned to a respective one of the multiple parking spots. Each of the NFC tags initiates a parking timer for a meter-less parking transaction for parking a vehicle in the respective one of the multiple parking spots responsive to a scanning thereof by an NFC-enabled user device. Each of the NFC tags has a customer device scannable NFC physical tag encoded with a unique identifier of the respective one of multiple parking spots to which it is assigned. The parking timer is stopped and a user is presented with a digital invoice amount due for a parking duration calculated with respect to a subsequent scan.

### BACKGROUND

### Technical Field

The present invention relates generally to Near Field Communication (NFC) devices, and more particularly to parking meter free NFC park and pay.

### Description of the Related Art

Parking a vehicle can often be a problematic experience. For example, a user must find the appropriate meter, often having to determine their particular occupied “spot”, and then pay the meter to park. This can be particularly problematic for disabled or elderly people who now have to travel more to deal with the meter in order to park their vehicle. Hence, there is a need for an expeditious way to pay for parking a vehicle without having to deal with an actual meter.

### SUMMARY

According to an aspect of the present invention, a Near Field Communication (NFC) system is provided for managing a parking area having multiple parking spots. The system includes a set of NFC tags. Each of the NFC tags is assigned to a respective one of the multiple parking spots. Each of the NFC tags initiates a parking timer for a meter-less parking transaction for parking a vehicle in the respective one of the multiple parking spots responsive to a scanning thereof by an NFC-enabled user device. Each of the NFC tags has a customer device scannable NFC physical tag encoded with a unique identifier of the respective one of multiple parking spots to which it is assigned. The parking timer is stopped and a user is presented with a digital invoice amount due for a parking duration calculated with respect to a subsequent scan.

According to another aspect of the present invention, a method is provided for using Near Field Communication (NFC) to manage a parking area having multiple parking spots. The method includes initiating, by each of NFC tags assigned to a respective one of the multiple parking spots, a parking timer for a meter-less parking transaction for parking a vehicle in the respective one of the multiple parking spots responsive to a scanning thereof by an NFC-enabled user device. Each of the NFC tags has a customer device scannable NFC physical tag encoded with a unique identifier of the respective one of multiple parking spots to which it is assigned. The method further includes stopping the parking timer and presenting a user with a digital invoice amount due for a parking duration calculated with respect to a subsequent scan.

According to yet another aspect of the present invention, a Near Field Communication (NFC) system is provided for managing meter-less parking transactions for a parking area having multiple parking spots. The system includes a NFC check-in tag and a NFC check-out tag, both assigned to a respective set of multiple parking spots, and each having a customer device scannable NFC physical tag encoded with a unique identifier of the parking area. The system further includes a software application for managing the multiple parking spots responsive to user selections and relinquishments of available ones of the multiple parking spots. The software application further manages a parking timer. A scan of the NFC check-in tag by an NFC-enabled user device activates the software application for use in selecting one of the available ones of the multiple parking spots. A subsequent scan of the NFC check-out tag by the NFC-enabled user device stops the parking timer and causes a digital invoice to be presented in the software application for a meter-less parking transaction for the selected one of the available ones of the multiple parking spots.

According to still another aspect of the present invention, a method is provided for using Near Field Communication (NFC) to manage a parking area having multiple parking spots. The method includes assigning a NFC check-in tag and a NFC check-out tag to a respective set of multiple parking spots. Each of the NFC check-in tag and the NFC check-out tag has a customer device scannable NFC physical tag encoded with a unique identifier of the parking area. The method further includes managing, using a software application, the multiple parking spots responsive to user selections and relinquishments of available ones of the multiple parking spots. The method also includes managing, using the software application, a parking timer. A scan of the NFC check-in tag by an NFC-enabled user device activates the software application for use in selecting one of the available ones of the multiple parking spots. A subsequent scan of the NFC check-out tag by the NFC-enabled user device stops the parking timer and causes a digital invoice to be presented in the software application for a meter-less parking transaction for the selected one of the available ones of the multiple parking spots.

According to a further aspect of the present invention, a Near Field Communication (NFC) system is provided for managing multiple parking spots. The system includes a NFC tag assigned to and installed on a vehicle. The NFC tag initiates a parking timer for a meter-less parking transaction for parking the vehicle in a respective one of the multiple parking spots responsive to a scanning of the NFC tag by an NFC-enabled user device. The NFC tag has a customer device scannable NFC physical tag encoded with a unique identifier of the vehicle to which it is assigned. The parking timer is stopped and a user is presented with a digital invoice amount due for a parking duration calculated with respect to a subsequent scan by the NFC enabled device.

According to an additional aspect of the present invention, a method is provided for using Near Field Communication (NFC) to manage multiple parking spots. The method includes assigning a NFC tag to a vehicle, the NFC tag initiating a parking timer for a meter-less parking transaction for parking the vehicle in a respective one of the multiple parking spots responsive to a scanning of the NFC tag by an NFC-enabled user device. The NFC tag has a customer device scannable NFC physical tag encoded with a unique identifier of the vehicle to which it is assigned. The parking timer is stopped and a user is presented with a digital invoice amount due for a parking duration calculated with respect to a subsequent scan by the NFC enabled device.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary processing system to which the present invention may be applied, in accordance with an embodiment of the present invention;

FIG. 2 is a block diagram showing an exemplary environment to which the present invention can be applied, in accordance with an embodiment of the present invention;

FIG. 3 is a flow diagram showing an exemplary method for NFC park and pay, in accordance with an embodiment of the present invention;

FIG. 4 is a block diagram showing an exemplary screen display of a NFC-enabled user device relating to the method of FIG. 3, in accordance with an embodiment of the present invention;

FIG. 5 is a block diagram showing another exemplary environment to which the present invention can be applied, in accordance with an embodiment of the present invention;

FIG. 6 is a flow diagram showing another exemplary method for NFC park and pay, in accordance with an embodiment of the present invention;

FIG. 7 is a block diagram showing an exemplary screen display of a NFC-enabled user device relating to the method of FIG. 6, in accordance with an embodiment of the present invention;

FIG. 8 is a block diagram showing another exemplary screen display of a NFC-enabled user relating to the method of FIG. 6, in accordance with an embodiment of the present invention;

FIG. 9 is a block diagram showing yet another exemplary environment to which the present invention can be applied, in accordance with an embodiment of the present invention;

FIG. 10 is a flow diagram showing yet another exemplary method for NFC park and pay, in accordance with an embodiment of the present invention;

FIG. 11 is a flow diagram showing an exemplary initial method of setting up NFC tags, in accordance with an embodiment of the present invention;

FIG. 12 is a flow diagram showing an exemplary initial method performed responsive to a client (parking management entity) setting up the system for their specific company before allowing customers to use the parking spots/lot, in accordance with an embodiment of the present invention;

FIG. 13 is a flow diagram showing an exemplary initial method performed responsive to a user setting up the system for their specific vehicle, in accordance with an embodiment of the present invention; and

FIG. 14 is a flow diagram showing an exemplary parking enforcement method, in accordance with an embodiment of the present invention.

### DETAILED DESCRIPTION

The present invention is directed to parking meter free NFC park and pay.

Advantageously, the present invention allows a vehicle operator to park and pay in a parking spot without having to interact with a meter. Rather, an efficient NFC-based approach enables a user to effortlessly pay for the parking spot using a NFC-enabled user device such as, for example, a smart phone. Various NFC-based park and pay approaches are described herein, thus allowing flexibility depending upon the implementation.

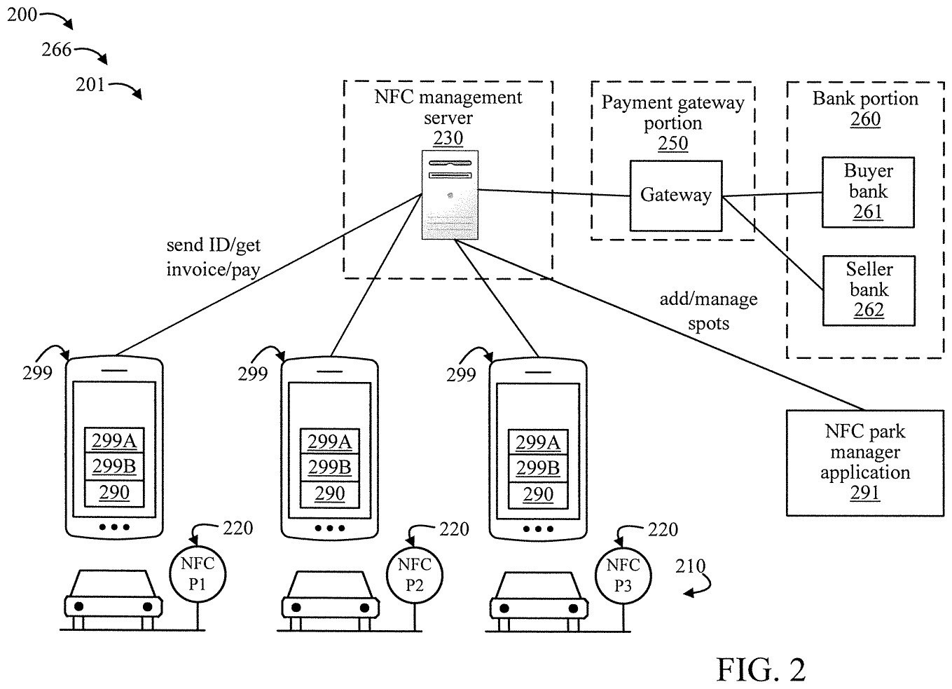

In an embodiment (see, e.g., FIG. 2-4), a respective NFC tag, which include a Near Field Communication (NFC) chip, is assigned to each parking spot, for example, in a parking lot or parking area. Each NFC tag can be encoded and assigned with the unique ID of the parking spot with which it is assigned and can include a parking management or ownership company's banking info to facilitate payment for parking. A user pulls into a parking spot, opens a NFC park and pay application, scans the tag for the parking spot they currently occupy using the NFC park and pay application and, upon conclusion of the parking session, initiates a payment transaction to pay for the parking, all without the need for using a meter device and thus providing meter-free NFC parking. In an embodiment, a respective NFC tag can be installed (e.g., as a waterproof sticker) on existing meters in order to provide alternate, meter-free NFC parking in place of using the meter. In such a case, the functionality of the meter is avoided, as the only involvement the meter has is being a mounting place for the NFC tag that is scanned in order to perform the payment transaction.

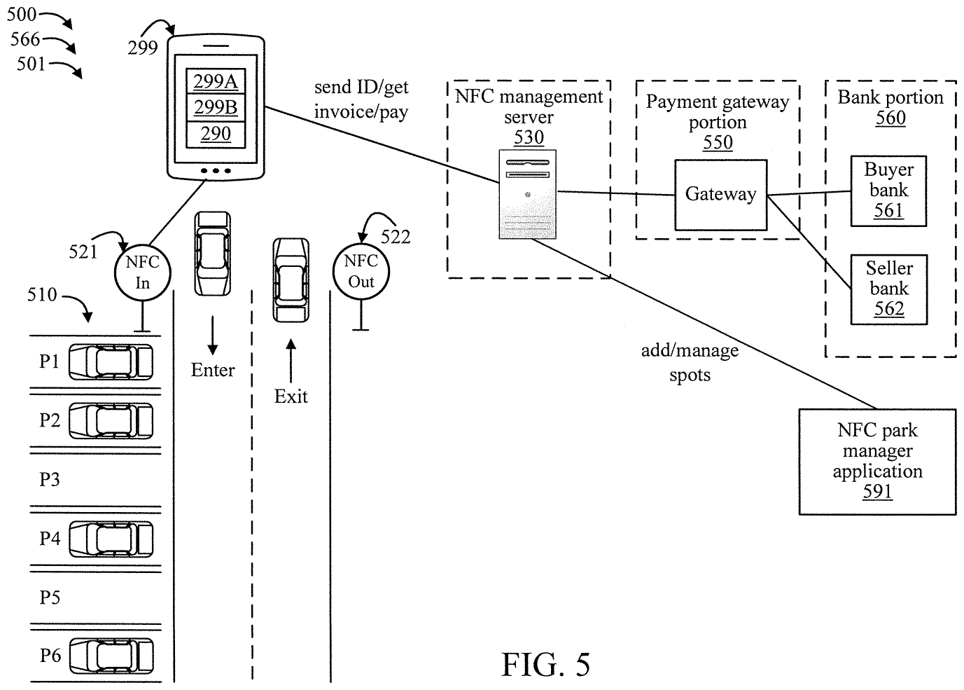

In another embodiment (see, e.g., FIGS. 5-8), a NFC check-in tag and a NFC check-out tag are located at an entrance and an exit, respectively, of a parking lot or parking area. Upon scanning the NFC check-in tag, a NFC park and pay application is opened which shows occupied and available parking spots. Upon the user selecting a particular available parking spot, the user actuates a start timer button in the NFC park and pay application to commence the starting of a parking timer for the selected parking spot. Upon a conclusion of the parking session, the user scans the NFC check-out tag which stops the timer, and starts a payment transaction for the parking, all without the need for using a meter device and thus providing meter-free NFC parking.

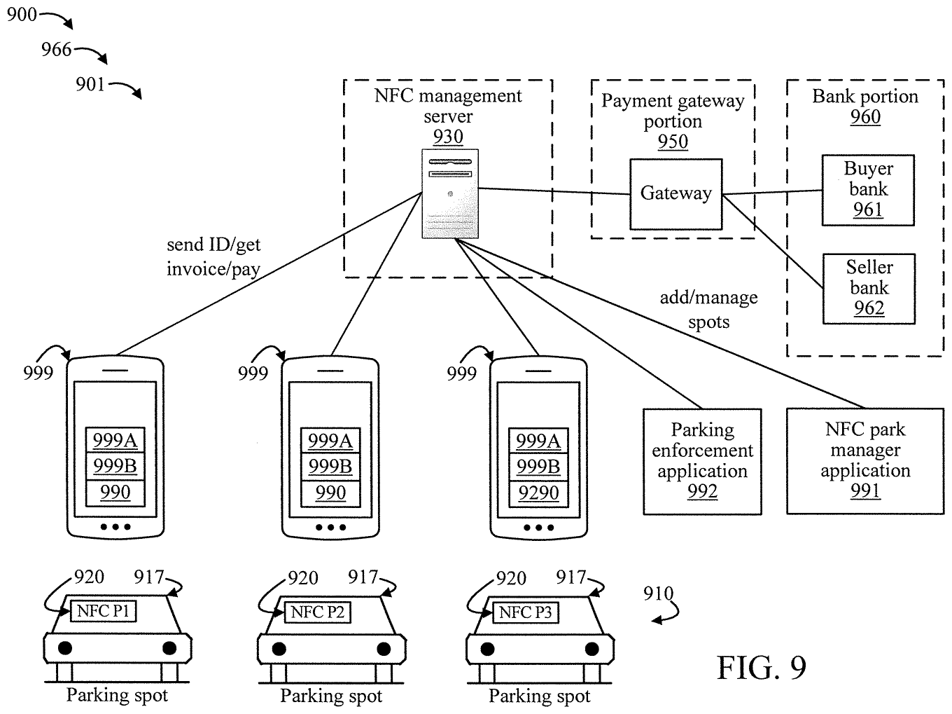

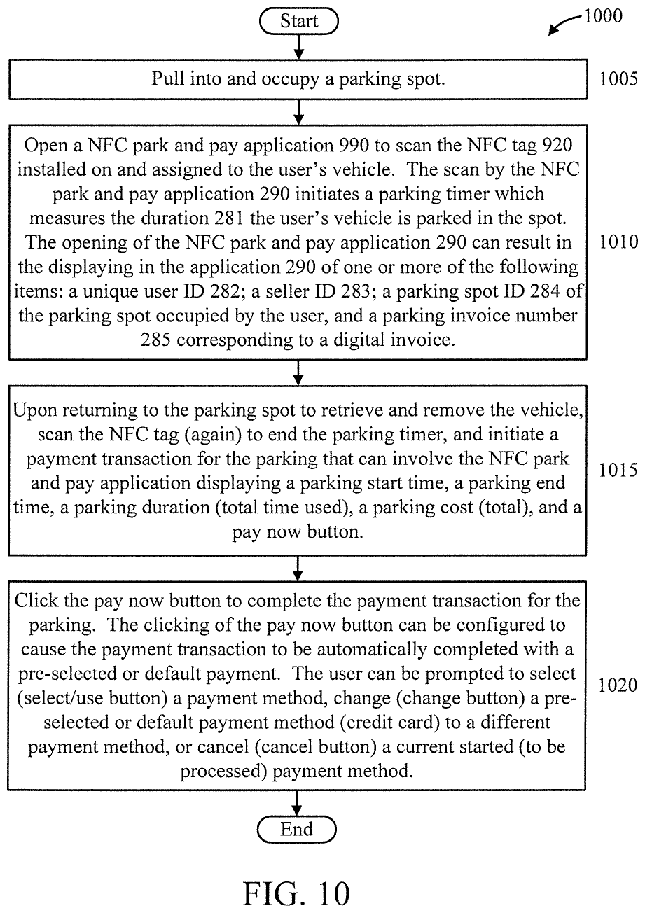

In yet another embodiment (see, e.g., FIGS. 9-10), a user registers with a registration authority (e.g., a computing platform of the present invention and/or the Department of Motor Vehicles (DMW) in order to receive a validated NFC tag in the form of a NFC sticker. The NFC sticker is installed on the windshield of the registered user's vehicle and allows a user to scan the NFC sticker without ever having to leave their vehicle. Hence, upon arriving at an authorized (for use) parking spot, the user scans the NFC sticker to actuate a parking timer for meter-free NFC parking. A parking enforcement officer can scan the NFC tag on the windshield to see if the meter is active or not (e.g., timed out, not used altogether, etc.). To that end, the parking enforcement officer can have an application a device under their control that has a validation function to check if a sticker is in use and active or timed out. If the sticker was never used for the spot or is timed out, then the parking enforcement officer can issue a ticket to the driver of the vehicle. The ticket can be a paper ticket written by the officer or can be an automated ticket sent, e.g., via email, using user information retrieved from the sticker. To that end, the sticker can be encoded with information that uniquely identifies each user from each other.

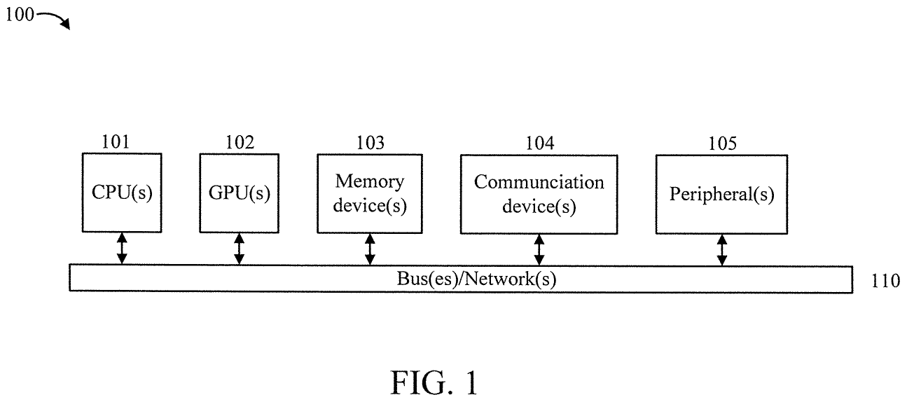

FIG. 1 is a block diagram showing an exemplary processing system 100 to which the present invention may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. At least one Graphics Processing Unit (GPU) 194 is operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

Moreover, it is to be appreciated that environments 200, 500, and 900 described below with respect to FIGS. 2, 5, and 9, respectively, are environments for implementing respective embodiments of the present invention. Part or all of processing system 100 may be implemented in one or more of the elements of environment 200 and/or environment 500 and/or environment 900.

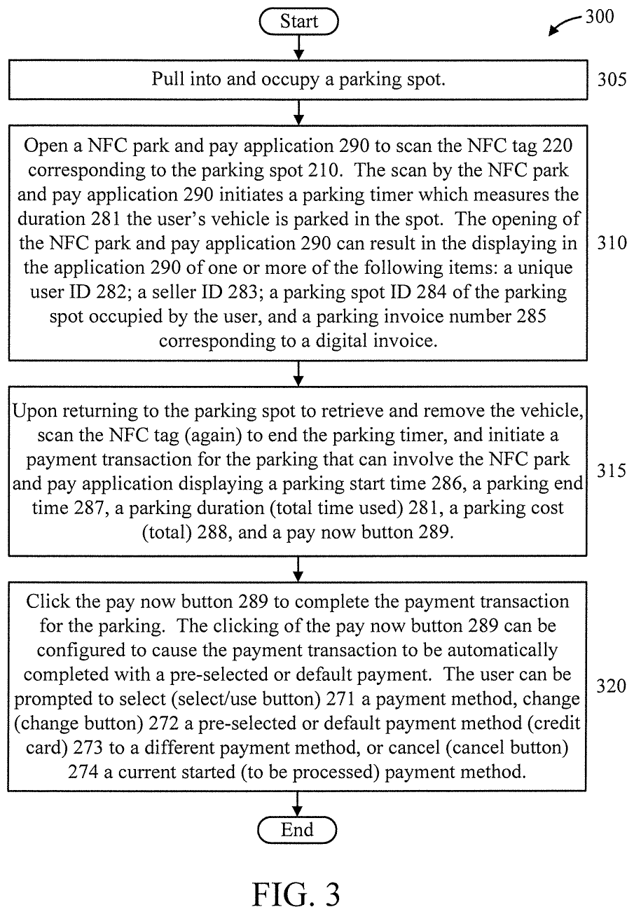

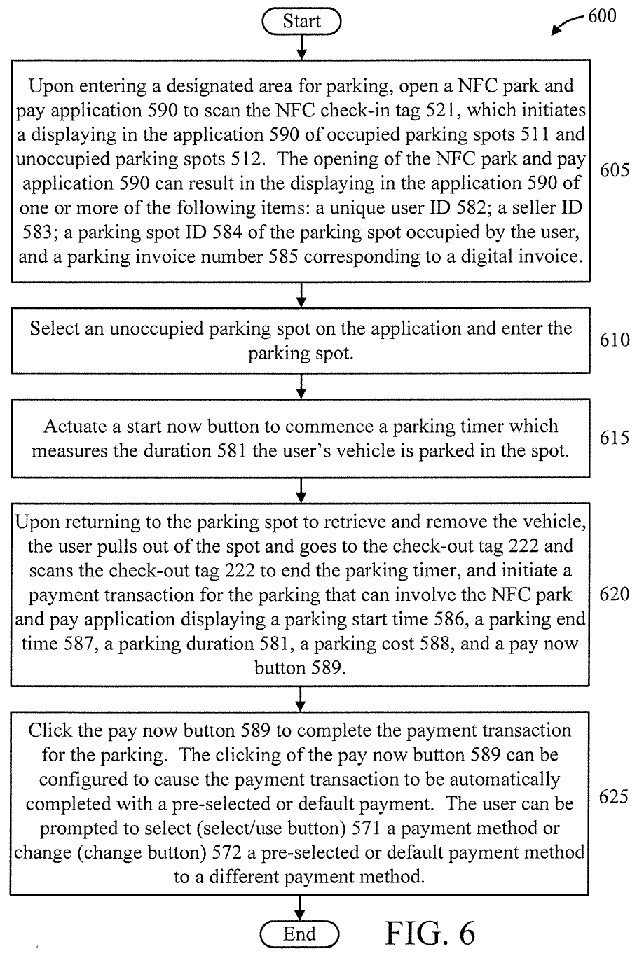

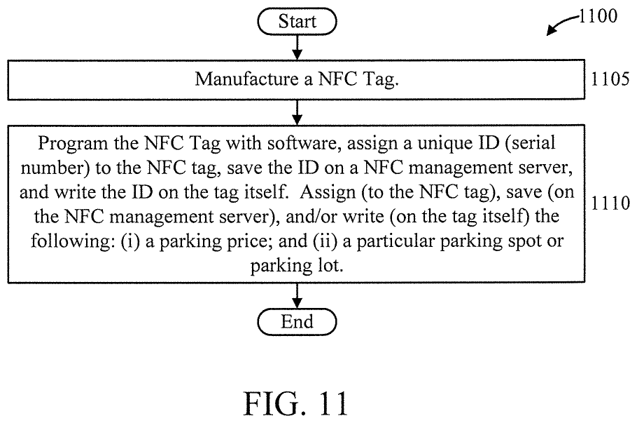

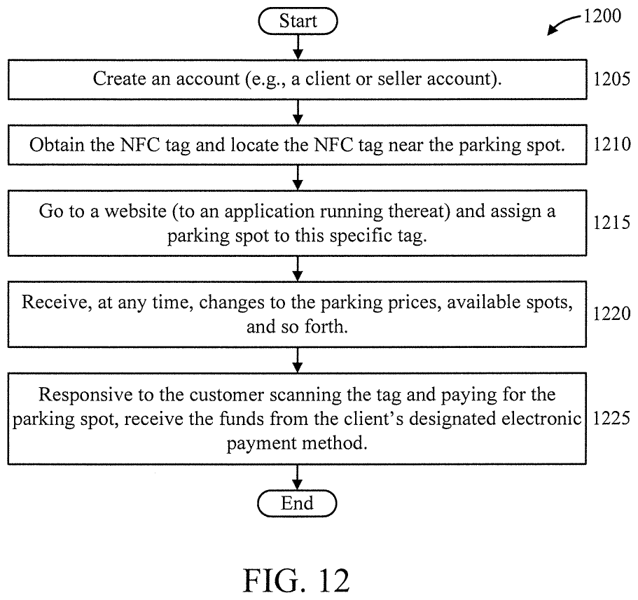

Further, it is to be appreciated that processing system 100 may perform at least part of the method described herein including, for example, at least part of method 300 of FIG. 3 and/or at least part of method 600 of FIG. 6 and/or at least part of method 1000 of FIG. 10 and/or at least part of method 1100 of FIG. 11, and/or at least part of method 1200 of FIG. 12. Also, part or all of environment 200 may be used to perform at least part of method 300 of FIG. 3, and part or all of environment 500 may be used to perform at least part of method 600 of FIG. 6 and/or at least part of method 1000 of FIG. 10 and/or at least part of method 1100 of FIG. 11 and/or at least part of method 1200 of FIG. 12.

Hence, as noted above, FIGS. 2, 5, and 9 show respective different embodiments of the present invention. However, it is to be appreciated that elements from one embodiment can be used in another one of the embodiments and vice versa, as readily appreciated by one of ordinary skill in the art given the teachings of the present invention provided herein, while maintaining the spirit of the present invention.

FIG. 2 is a block diagram showing an exemplary environment 200 to which the present invention can be applied, in accordance with an embodiment of the present invention.

The environment 200 includes multiple parking spots 210, multiple NFC tags 220, a NFC management server 230, and a payment gateway portion 250, and a banking portion 260.

The various elements of the environment 200 can be considered to form a Near Field Communication (NFC) system 201 which interfaces with other elements such as NFC-enabled user devices 299. The environment 200/NFC system 201 interfaces with the NFC-enabled user devices 299 using a NFC park and pay application 290 which can be resident on or accessible by the NFC-enabled user devices 299.

The NFC tags 220 and/or the NFC management server 230 and/or the NFC park and pay application 290 and/or the NFC park manager application 291 can be part of a computing platform 266 for implementing one or more embodiments of the present invention. In an embodiment, a cloud computing platform can be used. In an embodiment, the NFC management server 230 and/or at least part of the application 299 can be implemented as one or more nodes in a cloud computing environment. While one NFC management server 230 is shown in the illustrative example of FIG. 2, in other embodiments, more than one server can be used, with each corresponding to a particular parking lot owner, parking lot manager, parking lot, geographical region, and so forth, depending upon the implementation.

Each of the NFC-enabled user devices 299 has a NFC scanning capability, via a NFC scanner 299A, for scanning the NFC checkout price tags 220. Each of the NFC-enabled user devices 299 further can have another type of communication capability, via a transceiver 299B, for communicating with the NFC management server 230. For example, cellular, WIFI, Bluetooth, and so forth can be used.

Each of the multiple parking spots 210 is associated with a respective one of the NFC tags 220 such that each NFC tag 220 has a unique identifier in order to distinguish between the multiple parking spots 210. In an embodiment, each NFC tag 220 can include a Near Field Communication (NFC) chip. The NFC tag 220 can be encoded and assigned with the unique ID of a parking spot, the unique ID of a company (parking lot owner, parking lot manager, etc.), as well as a company's banking info for facilitating payment for parking. In an embodiment, the NFC tags 220 are implemented as stickers that can be stuck on fixed objects (e.g., poles) proximate to the spots to which they are assigned. In an embodiment, a printer having the ability to print using electrically conductive ink can implement printing a NFC antenna with a NFC chip as a NFC tag including in sticker form.

The NFC management server 230 manages the NFC tags 220 and performs payment transactions through the payment gateway portion 250 and the banking portion 260. The NFC management server 230 can be located proximate to the parking spot(s) or remote from the parking spot(s) (e.g., using a cloud configuration). The NFC management server 230 interfaces with the NFC park and play application 290 on the NFC-enabled user devices 299 as well as the NFC park manager application 291 used by registered parking spot owners or managers to add and manage parking spots for parking use.

Preferably, the NFC tags 220 are installed on mounting objects (e.g., poles, etc.). Preferably, the mounting objects are reachable from a person's vehicle without them having to get out of their vehicle. Accordingly, a user would put their NFC-enabled user device 299 (e.g., smart phone, laptop, tablet, smart watch, etc.) up to the NFC tag 220 for their parking spot 210 in order to scan the NFC tag 220 and initiate a parking timer for a (meter-free) payment transaction.

In another embodiment, a directional, low-power transmitter can be used to broadcast the NFC information from the NFC tag directly to the user's vehicle and hence the user's device 299 in order to avoid the user having to lower their window and reach outside of their vehicle (in the case of a car) to hold up their phone to the NFC tag 220 itself.

These and other arrangements are readily determined given the teachings of the present invention provided herein, while maintaining the spirit of the present invention.

The payment gateway portion 250 can include, for example, but is not limited to, payment services such as, for example, but not limited to, PayPal®, and so forth.

The banking portion 260 can include a user bank portion 261 and a parking manager or parking owner bank portion 262 for supporting a parking transaction therebetween.

In an embodiment, the computing platform 266, through at least the NFC management server 230, receives any particular one of a plurality of customer selectable electronic payment services. The plurality of customer selectable electronic payment services can include, for example, but are not limited to, at least one e-banking system internal to and implemented by a respective one of the plurality of sellers. The purchase transaction is meter-free, payment terminal free, and bank wire transfer free, by the system automatically invoking at least one electronic payment service which is (i) adapted for use on a mobile device of a customer parking their vehicle and (ii) accepted by the authority accepting payment for parking. Any of a number of available electronic payment services adapted to, or certainly readily usably by mobile devices, can be used including, but not limited to credit cards, PayPal®, etc.

FIG. 3 is a flow diagram showing an exemplary method 300 for NFC park and pay, in accordance with an embodiment of the present invention. The method 300 is performed by a user who intends to park their car and pay for the parking using the present invention.

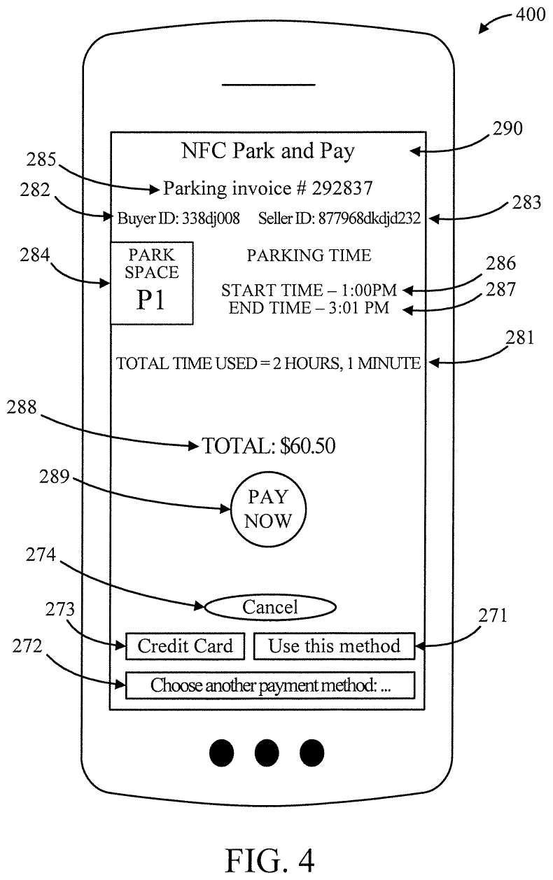

FIG. 4 is a block diagram showing an exemplary screen display 400 of a NFC-enabled user device relating to method 300 of FIG. 3, in accordance with an embodiment of the present invention.

Referring to FIGS. 2, 3, and 4, at block 305, pull into and occupy a parking spot.

At block 310, open a NFC park and pay application 290 to scan the NFC tag 220 corresponding to the parking spot 210. The scan by the NFC park and pay application 290 initiates a parking timer which measures the duration 281 the user's vehicle is parked in the spot. The opening of the NFC park and pay application 290 and the scan are performed by a NFC-enabled user device 290. The opening of the NFC park and pay application 290 can result in the displaying in the application 290 of one or more of the following items: a unique user identifier (ID) 282; a seller (parking authority (e.g., owner, manager, etc.)) ID 283; a parking spot ID 284 of the parking spot occupied by the user, and a parking invoice number 285 corresponding to a digital invoice.

At block 315, upon returning to the parking spot to retrieve and remove the vehicle, scan the NFC tag (again) to end the parking timer, and initiate a payment transaction for the parking that can involve the NFC park and pay application displaying a parking start time 286, a parking end time 287, a parking duration (total time used) 281, a parking cost (total) 288, and a pay now button 289.

At block 320, click the pay now button 289 to complete the payment transaction for the parking. Relating to block 320, the clicking of the pay now button 289 can be configured to cause the payment transaction to be automatically completed with a pre-selected or default payment. In an embodiment, the user can be prompted to select (select/use button) 271 a payment method, change (change button) 272 a pre-selected or default payment method (credit card) 273 to a different payment method, or cancel (cancel button) 274 a current started (to be processed) payment method. In an embodiment, completion of the payment transaction for the parking involves sending confirmation (of the actuation of the pay now button 289) from the user device to the server, receiving the confirmation by the server, and deducting the amount specified in the invoice from the user's PayPal or credit card.

FIG. 5 is a block diagram showing another exemplary environment 500 to which the present invention can be applied, in accordance with an embodiment of the present invention.

The environment 200 includes multiple parking spots 510, an NFC check-in tag 521, a NFC check-out tag 522, a NFC management server 530, and a payment gateway portion 550, and a banking portion 560.

The various elements of environment 500 can be considered to form a Near Field Communication (NFC) system 501 which interfaces with other elements such as NFC-enabled user devices 599. The environment 200/NFC system 201 interfaces with the NFC-enabled user devices 599 using a NFC park and pay application 590 which can be resident on or accessible by the NFC-enabled user devices 599.

Each of the NFC-enabled user devices 599 has a NFC scanning capability, via a NFC scanner 599A, for scanning the NFC checkout price tags. Each of the NFC-enabled user devices 599 further can have another type of communication capability, via a transceiver 599B, for communicating with the NFC management server 530. For example, cellular, WIFI, Bluetooth, and so forth can be used.

The check-in NFC tag 521 and check-out NFC tag 522 can be located proximate to each other or remote from each other, depending upon the arrangement of the parking lot. In an embodiment, the check-in NFC tag 521 and check-out NFC tag 522 can be installed on mounting objects (e.g., poles, etc.). Preferably, the mounting objects are reachable from a person's vehicle without them having to get out of their vehicle. Accordingly, a user would put their NFC-enabled user device 599 (e.g., smart phone, laptop, tablet, smart watch, etc.) up to the check-in NFC tag 221 in order to scan the NFC tag 220 and initiate a showing of occupied and unoccupied parking spots in a display portion of the application 590 on the NFC enabled user device 599. In an embodiment, each NFC tag 521 and 522 can include a Near Field Communication (NFC) chip. The NFC tags 521 and 522 can be encoded and assigned with the unique ID of a parking lot or parking area having multiple parking spots, the unique ID of a company (parking lot owner, parking lot manager, etc.), as well as a company's banking info for facilitating payment for parking. In an embodiment, the NFC tags 220 are implemented as stickers that can be stuck on fixed objects (e.g., poles) proximate to the spots to which they are assigned.

Scanning of the check-in NFC tag 521 activates a NFC park and pay application 590 on the user's device 599 (e.g., smart phone, laptop, tablet, smart watch, etc.).

The NFC park and pay application 590 will show which parking spaces are occupied (e.g., marked by an X and optionally shown in Red, or using some other indication) and which parking spaces are unoccupied (e.g., not marked by an X and optionally shown in Yellow or using some other indication). It is noted that coloring is not shown in the Figures and, thus, an X is simply used to mark occupied spaces, and a lack of an X is used to indicate an unoccupied space.

After the user selects a space and parks their vehicle there, the user can actuate a start button which starts a parking timer. During the duration the vehicle is parked, the NFC park and pay application 590 will show the start time and the current time used. When the user returns to their vehicle to leave, the user actuates a stop button in the NFC park and pay application 540 in order to stop the timer and calculate the final amount due for parking.

The payment gateway portion 550 can include, for example, but is not limited to, payment services such as, for example, but not limited to, PayPal®, and so forth.

The banking portion 560 can include a user bank portion 561 and a parking manager or parking owner bank portion 562 for supporting a (meter-free) parking transaction therebetween.

In an embodiment, the computing platform 566, through at least the NFC management server 230, receives any particular one of a plurality of customer selectable electronic payment services. The plurality of customer selectable electronic payment services can include, for example, but are not limited to, at least one e-banking system internal to and implemented by a respective one of the plurality of sellers. The purchase transaction is meter-free, payment terminal free, and bank wire transfer free, by the system automatically invoking at least one electronic payment service which is (i) adapted for use on a mobile device of a customer parking their vehicle and (ii) accepted by the authority accepting payment for parking. Any of a number of available electronic payment services adapted to, or certainly readily usably by mobile devices, can be used including, but not limited to credit cards, PayPal®, etc.

FIG. 6 is a flow diagram showing another exemplary method 600 for NFC park and pay, in accordance with an embodiment of the present invention. The method 600 is performed by a user who intends to park their vehicle and pay for the parking using the present invention.

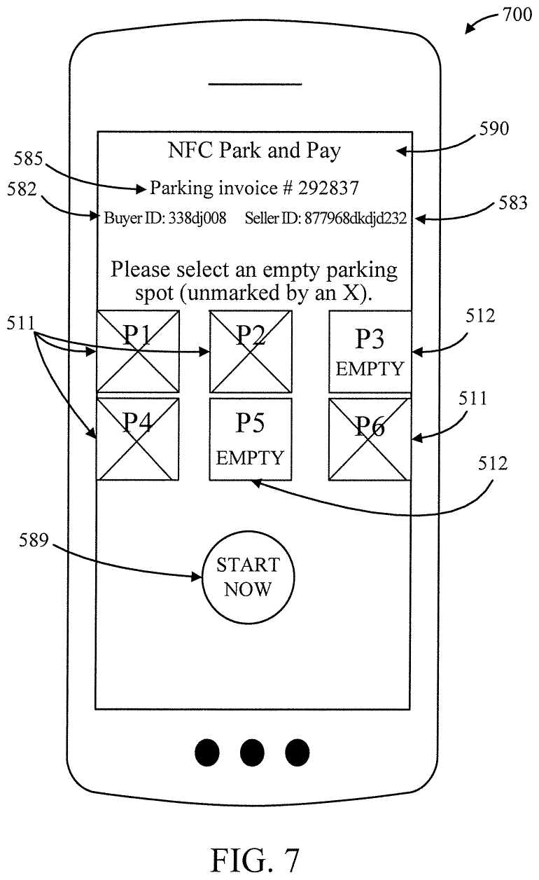

FIG. 7 is a block diagram showing an exemplary screen display 700 of a NFC-enabled user device relating to method 600 of FIG. 6, in accordance with an embodiment of the present invention.

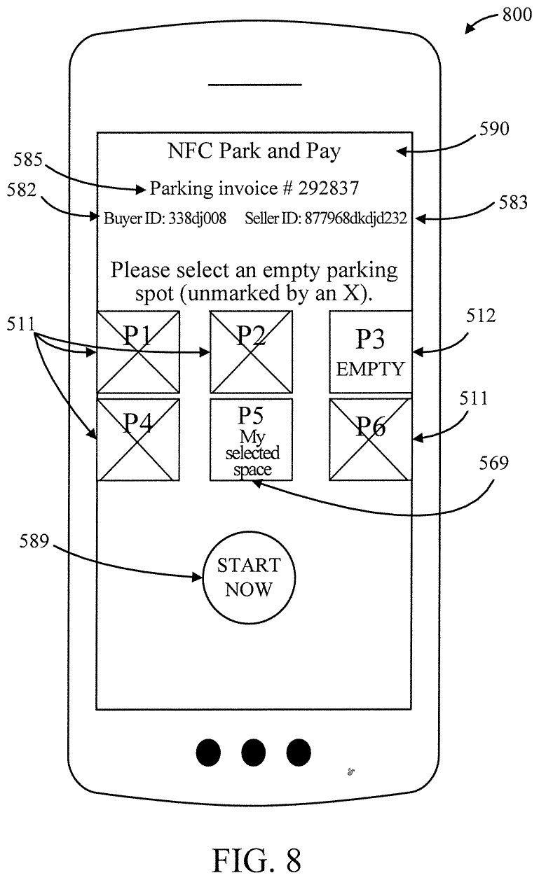

FIG. 8 is a block diagram showing another exemplary screen display 800 of a NFC-enabled user relating to method 600 of FIG. 6, in accordance with an embodiment of the present invention.

Referring to FIGS. 6-8, at block 605, upon entering a designated area for parking, open a NFC park and pay application 590 to scan the NFC check-in tag 521, which initiates a displaying in the application 590 of occupied parking spots 511 and unoccupied parking spots 512. The opening of the NFC park and pay application 590 can result in the displaying in the application 590 of one or more of the following items: a unique user identifier (ID) 582; a seller (parking authority (e.g., owner, manager, etc.)) ID 583; a parking spot ID 584 of the parking spot occupied by the user, and a parking invoice number 585 corresponding to a digital invoice.

At block 610, select an unoccupied parking spot on the application (which will now be indicated as “my selected space” 569 in the application 590) and enter the parking spot.

At block 615, actuate a start now button to commence a parking timer which measures the duration 581 the user's vehicle is parked in the spot.

At block 620, upon returning to the parking spot to retrieve and remove the vehicle, the user pulls out of the spot and goes to the check-out tag 222 and scans the check-out tag 222 to end the parking timer, and initiate a payment transaction for the parking that can involve the NFC park and pay application displaying a parking start time 586, a parking end time 587, a parking duration 581, a parking cost 588, and a pay now button 589. In another embodiment, the user can scan the check-out tag while walking back to their car in order to end the parking timer and initiate the payment transaction. In an embodiment, another timer can be activated that gives the user a preset amount of time to pull out, where the user is not further charged if they pull out within the preset time or are otherwise can be charged a surcharge.

At block 625, click the pay now button 589 to complete the payment transaction for the parking. Relating to block 625, the clicking of the pay now button 589 can be configured to cause the payment transaction to be automatically completed with a pre-selected or default payment. In an embodiment, the user can be prompted to select (select/use button) 571 a payment method or change (change button) 572 a pre-selected or default payment method to a different payment method. Further relating to block 625, the same can involve a display as shown in FIG. 4 regarding completing the payment transaction for the parking.

In an embodiment, completion of the payment transaction for the parking involves sending confirmation (of the actuation of the pay now button 289) from the user device to the server, receiving the confirmation by the server, and deducting the amount specified in the invoice from the user's PayPal or credit card.

FIG. 9 is a block diagram showing yet another exemplary environment 900 to which the present invention can be applied, in accordance with an embodiment of the present invention.

The environment 900 includes multiple parking spots 910, multiple NFC tag 920, a NFC management server 930, and a payment gateway portion 950, and a banking portion 960.

The various elements of the environment 900 can be considered to form a Near Field Communication (NFC) system 901 which interfaces with other elements such as NFC-enabled user devices 999. The environment 900/NFC system 901 interfaces with the NFC-enabled user devices 999 using a NFC park and pay application 990 which can be resident on or accessible by the NFC-enabled user devices 999.

The NFC tags 920 and/or the NFC management server 930 and/or the NFC park and pay application 290 and/or the NFC park manager application 991 can be part of a computing platform 266 for implementing one or more embodiments of the present invention. In an embodiment, a cloud computing platform can be used. In an embodiment, the NFC management server 930 and/or at least part of the application 999 can be implemented as one or more nodes in a cloud computing environment. While one NFC management server 930 is shown in the illustrative example of FIG. 9, in other embodiments, more than one server can be used, with each corresponding to a particular parking lot owner, parking lot manager, parking lot, geographical region, and so forth, depending upon the implementation.

Each of the NFC-enabled user devices 999 has a NFC scanning capability, via a NFC scanner 299A, for scanning the NFC checkout price tags 920. Each of the NFC-enabled user devices 999 further can have another type of communication capability, via a transceiver 999B, for communicating with the NFC management server 930. For example, cellular, WIFI, Bluetooth, and so forth can be used.

Each of the vehicles 917 is associated with a respective one of the NFC tags 920 such that each NFC tag 920 has a unique identifier in order to distinguish between the different vehicles 917. In an embodiment, each NFC tag 920 can include a Near Field Communication (NFC) chip. The NFC tag 920 can be encoded and assigned with the unique ID of a vehicle, the unique ID of a parking management entity (municipality, DMV, etc.), as well as the entity's and the user's banking info for facilitating payment for parking. In an embodiment, the NFC tags 920 are implemented as stickers that are stuck on windshields/windows of the vehicles to which they are assigned. In an embodiment, a printer having the ability to print using electrically conductive ink can implement printing a NFC antenna with a NFC chip as a NFC tag including in sticker form.

The NFC management server 930 manages the NFC tags 920 and performs payment transactions through the payment gateway portion 950 and the banking portion 960. The NFC management server 930 can be located proximate to the parking spot(s) or remote from the parking spot(s) (e.g., using a cloud configuration). The NFC management server 930 interfaces with the NFC park and play application 990 on the NFC-enabled user devices 999 as well as the NFC park manager application 991 used by the parking management entity to add and manage parking spots for parking use. In an embodiment, a parking enforcement application 992 can be used to interface with the NFC management server 930 and NFC tags in order to identify vehicles that have not used their NFC tags (nor paid using a conventional meter) for the purpose of issuing fines and/or traffic violation points on their license. While only shown in FIG. 9 for the sake of illustration, any of environments 200 and 500 can also have the parking enforcement application 992.

The NFC tags 920 are vehicle specific and are installed on the windshields of the vehicles to which they are assigned such that a user can scan the NFC tag 920 installed on their windshield and assigned to their vehicle without having to leave their vehicle. Accordingly, a user would put their NFC-enabled user device 999 (e.g., smart phone, laptop, tablet, smart watch, etc.) up to the NFC tag 920 installed on their windshield in order to scan the NFC tag 920 and initiate a parking timer for a (meter-free) payment transaction.

The payment gateway portion 950 can include, for example, but is not limited to, payment services such as, for example, but not limited to, PayPal®, and so forth.

The banking portion 960 can include a user bank portion 961 and a parking manager or parking owner bank portion 962 for supporting a parking transaction therebetween.

In an embodiment, the computing platform 966, through at least the NFC management server 930, receives any particular one of a plurality of customer selectable electronic payment services. The plurality of customer selectable electronic payment services can include, for example, but are not limited to, at least one e-banking system internal to and implemented by a respective one of the plurality of sellers. The purchase transaction is meter-free, payment terminal free, and bank wire transfer free, by the system automatically invoking at least one electronic payment service which is (i) adapted for use on a mobile device of a customer parking their vehicle and (ii) accepted by the authority accepting payment for parking. Any of a number of available electronic payment services adapted to, or certainly readily usably by mobile devices, can be used including, but not limited to credit cards, PayPal®, etc.

FIG. 10 is a flow diagram showing yet another exemplary method 1000 for NFC park and pay, in accordance with an embodiment of the present invention. The method 1000 is performed by a user who intends to park their car and pay for the parking using the present invention. For the sake of illustration, screen display 400 can also be considered to correspond to method 1000 and is hence not duplicated to avoid redundancy.

Referring to FIGS. 9 and 10, at block 1005, pull into and occupy a parking spot.

At block 1010, open a NFC park and pay application 990 to scan the NFC tag 920 installed on and assigned to the user's vehicle. The scan by the NFC park and pay application 990 initiates a parking timer which measures the duration the user's vehicle is parked in the spot. The opening of the NFC park and pay application 990 and the scan are performed by a NFC-enabled user device 990. The opening of the NFC park and pay application 990 can result in the displaying in the application 990 of one or more of the following items: a unique user identifier (ID); a seller (parking authority (e.g., owner, manager, etc.)) ID; a parking spot ID of the parking spot occupied by the user, and a parking invoice number corresponding to a digital invoice.

At block 1015, upon returning to the parking spot to retrieve and remove the vehicle, scan the NFC tag (again) to end the parking timer, and initiate a payment transaction for the parking that can involve the NFC park and pay application displaying a parking start time, a parking end time, a parking duration (total time used), a parking cost (total), and a pay now button.

At block 1020, click the pay now button to complete the payment transaction for the parking. Relating to block 1020, the clicking of the pay now button can be configured to cause the payment transaction to be automatically completed with a pre-selected or default payment. In an embodiment, the user can be prompted to select (select/use button) a payment method, change (change button) a pre-selected or default payment method (credit card) to a different payment method, or cancel (cancel button) a current started (to be processed) payment method. In an embodiment, completion of the payment transaction for the parking involves sending confirmation (of the actuation of the pay now button) from the user device to the server, receiving the confirmation by the server, and deducting the amount specified in the invoice from the user's PayPal or credit card.

Thus far, the actions performed by a user have been described with respect to FIGS. 3, 6 and 10. The following description relates to the parking lot owner or parking lot manager (hereinafter parking management entity) and actions performed on their end in order to realize an implementation of the present invention.

FIG. 11 is a flow diagram showing an exemplary initial method 1100 of setting up NFC tags, in accordance with an embodiment of the present invention.

At block 1105, manufacture a NFC Tag. The tag can be manufactured, for example, using a NFC writer, a readable/writable NFC chip, and a structure for holding the chip. The structure can be, for example, but is not limited to, a sticker, a card, a picture, a tag, a sign, and so forth.

At block 1110, program the NFC Tag with software, assign a unique ID (serial number) to the NFC tag, save the ID on a NFC management server, and write the ID on the tag itself. This ID can then be assigned to a parking spot or a parking lot for a parking management entity or to a particular vehicle. The software is configured to manage NFC tag functions such as receiving, storing, transmitting, and so forth. In an embodiment, the ID can include a parking price and an indication of a particular parking spot, or this information can be separately written on the tag and saved on the NFC management server. In an embodiment, the ID can include vehicle information (e.g., VIN or other unique identifier) particular to a specific vehicle in order to associate a particular NFC tag with that vehicle.

In an embodiment, the unique identifier can be associated with one of multiple parking management entities served by a NFC management server that manages the parking transaction for parking spots registered with the NFC management server with respect to the multiple parking management entities. For example, a particular subset of the unique identifier (1−m Most Significant Bits (MSBs) or 1−n Least Significant Bits (LSBs), etc.) could be used to identify the parking management entities with respect to each other. In an embodiment, 1−m MSBs are used to identify a parking management entity, and 1−n LSBs are used to identify a particular parking spot (or parking lot). Of course, other arrangements can be used while maintaining the spirit of the present invention.

In an embodiment, the subset of the ID used to identify the parking management entity can further be used to identify parking management entity related information (e.g., parking management entity payment information). In an embodiment, the server and/or the application on the user device can be used to identify the parking management entity related information, based on the subset of the ID used to identify the parking management entity.

FIG. 12 is a flow diagram showing an exemplary initial method 1200 performed responsive to a client (parking management entity) setting up the system for their specific company before allowing customers to use the parking spots/lot, in accordance with an embodiment of the present invention. The blocks of method 1200 are performed by the client.

At block 1205, create an account (e.g., a client account). In an embodiment, the client connects their product management system to the NFC system of the present invention and adds the details about their company to the NFC system. The account can involve user (company) name, email address, passcode, phone number, company profile, banking information and method, and so forth. In an embodiment, this process can be performed at a DMV or other entity office in order to create a user account for meter-free parking.

At block 1210, obtain the NFC tag and locate the NFC tag near the parking spot.

At block 1015, go to a website (to an application running thereat) and assign a parking spot to this specific tag.

At block 1220, receive, at any time, changes to the parking prices, available spots, and so forth.

At block 1225, responsive to the customer scanning the tag and paying for the parking spot, receive the funds from the client's designated electronic payment method.

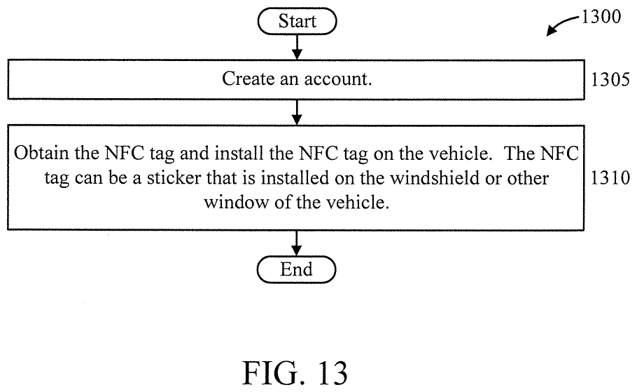

FIG. 13 is a flow diagram showing an exemplary initial method 1300 performed responsive to a user setting up the system for their specific vehicle, in accordance with an embodiment of the present invention. The blocks of method 1300 are performed by the user. Method 1300 is particularly suitable for use with respect to environment 900.

At block 1305, create an account (e.g., a user account). In an embodiment, the user connects to the NFC system of the present invention and adds the details about their vehicle and themselves to the NFC system. The account can involve a vehicle identifier (e.g., VIN or other number), user name, email address, passcode, phone number, company profile, banking information and method, and so forth.

At block 1310, obtain the NFC tag and install the NFC tag on the vehicle. In an embodiment, the NFC tag can be a sticker that is installed on the windshield or other window of the vehicle.

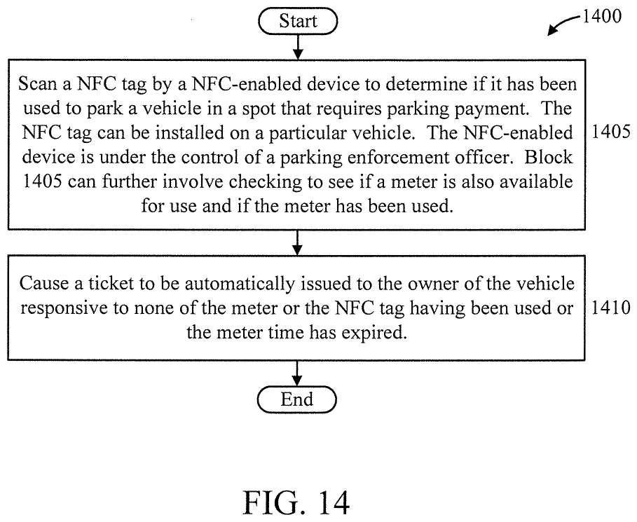

FIG. 14 is a flow diagram showing an exemplary parking enforcement method 1400, in accordance with an embodiment of the present invention. The blocks of method 1400 are performed by a parking enforcement officer. Method 1400 can be performed relative to any of environments 200, 500 and 900.

At block 1405, scan a NFC tag by a NFC-enabled device to determine if it has been used to park a vehicle in a spot that requires parking payment. The NFC tag can be installed on a particular vehicle. The NFC-enabled device is under the control of a parking enforcement officer. In an embodiment, block 1405 can further involve checking to see if a meter is also available for use and if the meter has been used.

At block 1410, cause a ticket to be automatically issued to the owner of the vehicle responsive to none of the meter or the NFC tag having been used or the meter time has expired. The ticket can be issued, for example, using email, Short Message Service (SMS), regular mail, and so forth. Preferably, an electronic method is used to issue the ticket such as, for example, email. The ticket is issued based on the unique identifier for the vehicle associated with the NFC tag.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A Near Field Communication (NFC) system for managing a parking area having multiple parking spots, the system comprising:
a set of NFC tags, each of the NFC tags being assigned to a respective one of the multiple parking spots, each of the NFC tags initiating a parking timer for a meter-less parking transaction for parking a vehicle in the respective one of the multiple parking spots responsive to a scanning thereof by an NFC-enabled user device, each of the NFC tags having a customer device scannable NFC physical tag encoded with a unique identifier of the respective one of multiple parking spots to which it is assigned, wherein the parking timer is stopped and a user is presented with a digital invoice amount due for a parking duration calculated with respect to a subsequent scan.

2. The NFC system of claim 1, wherein the customer device is a mobile smart phone.

3. The NFC system of claim 1, further comprising a NFC management server for managing the meter-less parking transaction for each of the multiple parking spots.

4. The NFC system of claim 3, further comprising a computing platform, in signal communication with the NFC management server, for providing a registration service to owners and managers of parking areas to enable the owners and the managers to implement meter-less parking transactions for the parking areas.

5. The NFC system of claim 4, wherein the computing platform is a cloud-based computing platform, and wherein the registration service and the meter-less parking transactions are provided as respective cloud services using the cloud-based computing platform.

6. The NFC system of claim 3, wherein the NFC management server generates a customer payable invoice for the meter-less parking transaction, and transmits the customer payable invoice to the NNFC enabled user device.

7. The NFC system of claim 1, wherein the computing platform, through at least the NFC management server, is configured to receive a user selection of one of a plurality of available electronic payment services.

8. The NFC system of claim 1, wherein the NFC tags are each installed on a respective physical object proximate to a corresponding one of the multiple parking spots assigned thereto.

9. The NFC system of claim 1, wherein the NFC tags are each installed on a respective parking meter proximate to a corresponding one of the multiple parking spots assigned thereto in order to provide the meter-less parking transaction without operating the respective parking meter.

10. The NFC system of claim 1, wherein each of the NFC tags are implemented as a respective sticker having a readable NFC chip embedded therein.

11. The NFC system of claim 1, wherein the NFC tag comprises a directional transmitter having a power level below a threshold level to directionally transmit NFC tag data directly to the NFC enabled user device.

12. A method for using Near Field Communication (NFC) to manage a parking area having multiple parking spots, the method comprising:
initiating, by each of NFC tags assigned to a respective one of the multiple parking spots, a parking timer for a meter-less parking transaction for parking a vehicle in the respective one of the multiple parking spots responsive to a scanning thereof by an NFC-enabled user device, each of the NFC tags having a customer device scannable NFC physical tag encoded with a unique identifier of the respective one of multiple parking spots to which it is assigned; and
stopping the parking timer and presenting a user with a digital invoice amount due for a parking duration calculated with respect to a subsequent scan.

13. A non-transitory article of manufacture tangibly embodying a computer readable program which when executed causes a computer to perform the steps of claim 12.

14. A Near Field Communication (NFC) system for managing meter-less parking transactions for a parking area having multiple parking spots, the system comprising:
a NFC check-in tag and a NFC check-out tag, both assigned to a respective set of multiple parking spots, and each having a customer device scannable NFC physical tag encoded with a unique identifier of the parking area; and
a software application for managing the multiple parking spots responsive to user selections and relinquishments of available ones of the multiple parking spots, the software application further managing a parking timer, wherein a scan of the NFC check-in tag by an NFC-enabled user device activates the software application for use in selecting one of the available ones of the multiple parking spots, and wherein a subsequent scan of the NFC check-out tag by the NFC-enabled user device stops the parking timer and causes a digital invoice to be presented in the software application for a meter-less parking transaction for the selected one of the available ones of the multiple parking spots.

15. The NFC system of claim 14, wherein the customer device is a mobile smart phone.

16. The NFC system of claim 14, further comprising a NFC management server for managing the meter-less parking transactions for each of the multiple parking spots.

17. The NFC system of claim 16, further comprising a computing platform, in signal communication with the NFC management server, for providing a registration service to owners and managers of parking areas to enable the owners and the managers to implement meter-less parking transactions for the parking areas.

18. The NFC system of claim 17, wherein the computing platform is a cloud-based computing platform, and wherein the registration service and the meter-less parking transactions are provided as respective cloud services using the cloud-based computing platform.

19. The NFC system of claim 16, wherein the NFC management server generates a customer payable invoice for the meter-less parking transaction, and transmits the customer payable invoice to the NNFC enabled user device.

20. The NFC system of claim 14, wherein the NFC tags are each installed on a respective physical object proximate to a corresponding one of the multiple parking spots assigned thereto.

21. The NFC system of claim 14, wherein each of the NFC tags are implemented as a respective sticker having a readable NFC chip embedded therein.

22. The NFC system of claim 14, wherein the NFC tag comprises a directional transmitter having a power level below a threshold level to directionally transmit NFC tag data directly to the NFC enabled user device.

23. A method for using Near Field Communication (NFC) to manage a parking area having multiple parking spots, the method comprising:
assigning a NFC check-in tag and a NFC check-out tag to a respective set of multiple parking spots, each of the NFC check-in tag and the NFC check-out tag having a customer device scannable NFC physical tag encoded with a unique identifier of the parking area; and
managing, using a software application, the multiple parking spots responsive to user selections and relinquishments of available ones of the multiple parking spots,
managing, using the software application, a parking timer,
wherein a scan of the NFC check-in tag by an NFC-enabled user device activates the software application for use in selecting one of the available ones of the multiple parking spots, and wherein a subsequent scan of the NFC check-out tag by the NFC-enabled user device stops the parking timer and causes a digital invoice to be presented in the software application for a meter-less parking transaction for the selected one of the available ones of the multiple parking spots.

24. A non-transitory article of manufacture tangibly embodying a computer readable program which when executed causes a computer to perform the steps of claim 12.

25. A Near Field Communication (NFC) system for managing multiple parking spots, the system comprising:
a NFC tag assigned to and installed on a vehicle, the NFC tag initiating a parking timer for a meter-less parking transaction for parking the vehicle in a respective one of the multiple parking spots responsive to a scanning of the NFC tag by an NFC-enabled user device, the NFC tag having a customer device scannable NFC physical tag encoded with a unique identifier of the vehicle to which it is assigned, wherein the parking timer is stopped and a user is presented with a digital invoice amount due for a parking duration calculated with respect to a subsequent scan by the NFC enabled device.

26. The NFC system of claim 25, wherein the customer device is a mobile smart phone.

27. The NFC system of claim 25, further comprising a NFC management server for managing the meter-less parking transaction.

28. The NFC system of claim 27, further comprising a computing platform, in signal communication with the NFC management server, for providing a registration service to owners and managers of parking areas to enable the owners and the managers to implement meter-less parking transactions for the parking areas.

29. The NFC system of claim 28, wherein the computing platform is a cloud-based computing platform, and wherein the registration service and the meter-less parking transactions are provided as respective cloud services using the cloud-based computing platform.

30. The NFC system of claim 27, wherein the NFC management server generates a customer payable invoice for the meter-less parking transaction, and transmits the customer payable invoice to the NNFC enabled user device.

31. The NFC system of claim 25, wherein each of the NFC tags are implemented as a respective sticker having a readable NFC chip embedded therein.

32. The NFC system of claim 25, wherein the NFC tag comprises a directional transmitter having a power level below a threshold level to directionally transmit NFC tag data directly to the NFC enabled user device.

33. A method for using Near Field Communication (NFC) to manage multiple parking spots, the method comprising:
assigning a NFC tag to a vehicle, the NFC tag initiating a parking timer for a meter-less parking transaction for parking the vehicle in a respective one of the multiple parking spots responsive to a scanning of the NFC tag by an NFC-enabled user device, the NFC tag having a customer device scannable NFC physical tag encoded with a unique identifier of the vehicle to which it is assigned, wherein the parking timer is stopped and a user is presented with a digital invoice amount due for a parking duration calculated with respect to a subsequent scan by the NFC enabled device.

34. The method of claim 33, further comprising:
scanning, by another NFC enabled device, the NFC tag to verify a use of the NFC tag to park the vehicle in the respective one of the multiple parking spots; and
automatically issuing a ticket using email based on the unique identifier of the vehicle, responsive to a scan by the other NFC enabled device indicating a non-use of the NFC tag to park the vehicle in the respective one of the multiple parking spots.
